(19) United States
(12) Patent Application Publication
(10) Pub. No.: US 2026/0364936 A1
(43) Pub. Date: Nov. 19, 2026

(54) LAMINAR SUBSTRATE FEEDER AND PROCESSING MACHINE COUPLABLE THERETO

(71) Applicant: Jesús Francisco BARBERAN LATORRE, CASTELLDEFELS (BARCELONA) (ES)

(72) Inventor: Jesús Francisco BARBERAN LATORRE, CASTELLDEFELS (BARCELONA) (ES)

(21) Appl. No.: 19/488,014

(22) PCT Filed: Jun. 24, 2024
(86) PCT No.: PCT/ES2024/070393

§ 371 Date: Nov. 25, 2025

(30) Foreign Application Priority Data
Jun. 7, 2023 (EP) 23382557.9

(51) Int. Cl. B32B 38/18; B32B 41/00

(52) U.S. Cl. CPC B32B 38/18; B32B 41/00

(57) ABSTRACT

A laminar substrate feeder for processing machines that comprises:

—elements for supplying and guiding at least one stack of laminar substrates with an adjustable height gauge for the passage of a single laminar substrate at a time; —a feeding table with suction and with a plurality of wheels integral with at least one rotation axle for feeding the movement of the laminar substrate; —and traction element located after the gauge in the direction of movement of the laminar substrate to direct the laminar substrate to the processing machine, wherein the feeding table is stationary, and it comprises control element configured to selectively stop the rotation of the corresponding rotation axle.

### TECHNICAL FIELD

The present invention relates to feeder machines for laminar substrates such as cardboard sheets or corrugated cardboard for feeding to a cardboard processing machine, specifically for a machine for the application of preparation products such as e.g. the application of varnish or primer for subsequent digital printing.

### STATE OF THE ART

For the processing of cardboard, in particular for the application of decorative or marking motifs by means of digital printing, it is often necessary to apply a preparation product, varnish or primer prior to printing with ink. This process is carried out by a roller machine for applying preparation products which, by means of a combination of different rollers, applies a layer of a certain thickness of said preparation product to the cardboard surface. Conventionally, these machines, before the cardboard enters the applicator rollers, comprise a vacuum table with wheels to direct the cardboard to the applicator rollers in a suitable manner.

For process automation these machines are combined with a cardboard feeder which is configured to hold a stack of stacked cardboard sheets and feeds the same separately in the direction of the preparation machine. This cardboard feeder is arranged in place in stationary manner, and the preparation product application machine is attached thereto.

The feeder consists of a hopper or adjustable area for supplying the stacked cardboards, comprising an adjustable gauge that leaves a passage gap corresponding to the thickness of the cardboard sheet. The lower portion of said hopper has a table with a plurality of wheels for moving/feeding each cardboard sheet. In order to have a better traction, said feeding table comprises a suction table that sucks the cardboard sheet helping said wheels to better pull said cardboard sheet. In addition, at the exit of the gauge passage gap, the feeder comprises a lower feed roller and a corresponding press roller above the same to move the cardboard sheet to the feeding inlet of the preparation machine.

In an operating cycle of this feeder, the vacuum table sucks in a cardboard sheet, and by transmission of the rotation of the wheels said cardboard sheet moves in the direction of the preparation or processing machine with a speed according to the needs of the preparation machine. When the cardboard sheet exits through the gauge passage gap and its front flank reaches the feed roller and its press roller, the suction table is raised so that the wheels no longer have contact with the cardboard sheet (the wheels are stationary and the upper plate of the table is raised so that the horizontal line of tangency to the top of the wheels is below the upper level of the table plate to avoid contact), the wheels being driven by a single motor. However, the suction still exists, so that the outgoing cardboard sheet and the cardboard sheet immediately above the same, which is ready to come out, are sucked against the suction table, being a static element that causes retention of the cardboard sheet.

The outgoing cardboard sheet has sufficient traction to come out, due to the traction provided by the traction rollers, despite the retention caused by the raised suction table. At the same time, as the following cardboard sheet comes into contact with the raised suction table, it is retained, preventing the outgoing cardboard sheet from pulling the same. Thus, when the rear flank of the cardboard sheet reaches the gauge passage gap and is released from the cardboard bundle, the suction table is lowered to its initial position where the wheels come into contact with the following cardboard sheet to be extracted, starting the cycle again.

However, there are a number of problems with this process, resulting in defects in the cardboard sheets and lower productivity.

One of the problems that arises is the friction of the cardboard sheet with the suction table in its raised position, which requires extra energy efforts, or a higher treading of the press roller to achieve sufficient traction.

The need for the press roller to be able to pull the cardboard sheet when the wheels are no longer in contact with the cardboard sheet when the suction table is lifted means that certain cardboard sheets are marked by the treading of the press roller and are thus rendered unusable for further use.

Another problem caused by the raising and lowering of the suction table is damage to the perimeter ends due to tearing, breaking, bending, etc., caused by the guiding and retaining elements in the cardboard pack supply area. In addition, the same up and down movement of the suction table causes friction with the output gauge, again causing jams or damage that invalidates the cardboard sheet.

An additional problem arises due to the minimum length of cardboard sheet that must be fed in a given production process. During the operation of the feeder, in order to give the cardboard sheet enough time for the same to come sufficiently out of the gauge and to be pulled by the feed roller and its press roller, before the suction table has been raised and the traction of its wheels is lost, because the rear flank of the cardboard sheet passes over the first wheel axle and to prevent said wheels from feeding the following board prematurely, a minimum length must be left between the rear of the cardboard and the first wheel axle. This limitation leads to very short suction tables, which would not have sufficient traction force for the longer cardboard sheets that might be available in other production lines.

US Patent document US20220063938A1 addresses one of the problems mentioned above. Thus, in order to eliminate the press roller and avoid damaging the cardboard sheet, document US20220063938A1 discloses a feeder with a suction table and its corresponding wheels at the outlet of the gauge, achieving the necessary traction to feed the machine in this case for processing cardboard to make boxes. This alternative solves the above-mentioned problem of the press roller, however, the movement of the suction table will still cause friction on the perimeters of the cardboard sheet.

Another problem encountered in the feeder is in cases where it comprises two or more stacks of cardboard to be fed in parallel lines. In these cases, it is necessary to have an intermediate separator so that each cardboard sheet is positioned correctly in its travel line. As the feeding table with suction is moved, the separator cannot be supported as it would prevent the free movement of the suction table, leaving a gap between the separator and the feeding table. This situation means that the substrate being fed would not be guided on the side of the separator when the feeding table is down, so that jamming or misalignment of the substrate during its feed movement can occur.

In view of the described drawbacks or limitations of currently available solutions, a solution is required that avoids damage to the cardboard sheets, while at the same time providing faster movement of the cardboard sheets for feeding into a processing machine and smoother movements to avoid misalignment.

### OBJECT OF THE INVENTION

In order to meet this objective and solve the technical problems discussed so far, as well as providing additional advantages that can be derived later, the present invention provides a laminar substrate feeder for processing machines comprising:
elements for supplying and guiding at least one stack of laminar substrates with an adjustable height gauge for the passage of a single laminar substrate at a time,
a feeding table with suction with a plurality of wheels integral with at least one rotation axle for feeding by means of the movement of the laminar substrate,
and traction means located after the gauge in the direction of movement of the laminar substrate to direct the laminar substrate to the processing machine,
   wherein the feeding table is stationary, and comprises control means configured to selectively stop the rotation of the corresponding rotation axle.

With this configuration it is possible to keep the feeding table stationary, i.e. immobile to receive the laminar substrates on top, and to stop the rotation axle the wheels of which may interact with the following substrate ahead of time, the corresponding rotation axle being understood as the independently driven rotation axle or part of a group of axles, with a single independent drive, which will be selectively stopped according to substrate feeding requirements.

The rotation axle of the invention is understood to be the axles that have the function of pulling the substrate, whereby additional axles may exist, for example, in order to distribute the support of the load, but in this case without the added pulling function, said additional axles therefore not being comprised in the definition of a rotation axle according to the invention. However, they could also form part of a practical alternative to the invention.

This arrangement makes it possible to keep the suction table stationary without the need to be raised to avoid wheel traction as is the case in the state of the art. As a result, the substrate stack does not move, thus avoiding damage to the perimeter ends of said substrates due to friction with the guiding and retaining elements in the supply and feeding area of the laminar substrate stack. A supply area is understood as a hopper, or a hollow enclosed by walls that can be adjusted according to the dimensions of the laminar substrate.

Another of the problems present in the state of the art that is solved by the invention is that friction with the suction table is avoided when it is in the raised position. In the present invention the protruding substrate is always in contact with the traction wheels up to its exit from the passage gauge, which reduces the energetic efforts.

In addition, the maintenance of traction by the wheels makes it possible to move the substrate according to the required speed without the use of a press roller, or by reducing the tread pressure of said roller. The traction of the feed roller located at the outlet will be sufficient in addition to the traction provided by the wheels that maintain contact with the laminar substrate, which, in addition, since there is no friction with the suction table as in the state of the art, provides greater traction than in known solutions. This prevents the laminar substrate from being marked by the roller tread and having to be discarded.

Preferably the control means of the laminar substrate feeder subject of the invention are configured to stop the corresponding rotation axle prior to the laminar substrate following the laminar substrate being fed making contact with the wheels on said axle.

Preferably, the laminar substrate feeder of the invention comprises a plurality of rotation axles with their corresponding wheels, comprising drive means for each rotation axle and/or group of axles, and the control means being configured to stop the drive means corresponding to the axle or group of axles to be stopped prior to the laminar substrate following the laminar substrate being fed making contact with the wheels of the corresponding rotation axle.

In other words, the rotation axle, whether independently driven or forming part of a group of axles with the same drive to be stopped, shall be stopped before it makes contact with the following substrate to be fed, in order to avoid displacing the following substrate before it is due.

The moment at which the following substrate, which is being fed, could touch the wheels on a given axle, would mark the limit moment for stopping the rotation of said rotation axle, the stopping moment being determined by the control means. The stopping moment at which said following substrate would touch the wheels, being dependent on the distance between axles, substrate stiffness, substrate dimensions, substrate stack weight, substrate material density, etc.

In this way, said stopped axle will stop providing traction, preventing the following substrate from being pulled and causing jams. The stopping of the axles and their corresponding wheels shall preferably be successive with the passage of the laminar substrate until it exits through the passage gauge, all axles subsequently being driven again for a new feeding cycle of the laminar substrate.

Another advantage derived from the present invention is that it is no longer necessary to leave a minimum length of the substrate before its rear flank meets, during its removal, the first wheel axle so that it can be driven by the feeding roller as in the state of the art. With this solution it is possible to have a suction table as long as required.

According to a feature of the invention, the wheels integral with the rotation axle are configured to have a free movement in case their rotation axle is stopped.

In this way, the wheels will rotate together with the rotation axle but in the case where a rotation axle is stopped with a laminar substrate being fed, the wheels will be free to rotate to prevent the laminar substrate being fed from suffering wheel friction due to the stopping of the rotation axle. This configuration is particularly interesting when there are groups of axles driven by the same drive, so that when the drive is stopped, all axles are stopped, or if for safety reasons one of the rotation axles is to be stopped in feed before the rear flank of the substrate has passed, or for example if the substrate has already gained traction with the traction means located after the gauge.

In accordance with a feature of the invention, at least one rotation axle can rotate in the opposite direction to that corresponding to the movement of the laminar substrate, providing traction to the wheels in the opposite direction, being useful in the event of having to reposition a laminar substrate which for whatever reason has been pulled when it was not the right time to do so.

According to another feature of the invention, the feeding table comprises means for laterally moving the laminar substrate. The supplying and guiding elements of the laminar substrate feeder comprise a lateral guide or stop for the laminar substrate, however, to avoid jamming, a clearance of preferably about 0.5 mm on each side is left in relation to said guide. Thus, it can sometimes happen that the substrates are rotated with respect to their feeding direction due to said clearance.

Therefore, due to this table configuration with means for laterally moving the laminar substrate, it is possible to avoid misalignment of the laminar substrate for example by moving the substrate towards its left lateral guide to be fed referenced to said left guide.

These means for laterally moving the substrate may be in the form of an engraving on the table which tends to move the substrates laterally in their advance towards the feed, or at least one wheel configured to move the substrate laterally towards the corresponding lateral guide, which may be for example inclined axles, or wheels interspersed with the axles of the feeding wheels. In the latter case the wheels could be hidden for example according to a pneumatic mechanism by being hidden when the substrate has already been brought against the lateral guide. In the case of inclined axles, it is envisaged that after the substrate has been brought against the guide and its wheels are exposed, the inclined rotation axles are stopped, their wheels remaining free to rotate in the forward direction, the feed being carried out by the aforementioned feeding rotation axles.

Thanks to this configuration, it is possible to correct the alignment of the substrate, being linked to the feature that the feeding table is stationary, which would not be possible in the known state of the art.

Preferably, the traction means at the gauge outlet are at least a feeding roller, or a feeding roller with its corresponding press roller.

Even more preferably, the traction means at the gauge outlet are a secondary feeding table with suction and with moving wheels with independently driven axles and/or axles driven jointly by a single or several drives. This configuration is made possible by the maintenance of traction by the feeding table wheels that maintain contact with the outgoing substrate. The combination of a secondary suction table at the gauge outlet, together with a feeding roller, is also envisaged, depending on the speed requirements of the processing machine.

Preferably the drive means are servomotors, which facilitates greater control of wheel acceleration and braking.

According to a feature of the invention, the feeding table comprises at least two suction areas, the control means being configured to selectively activate/deactivate said suction areas. This segmented suction table configuration is an interesting embodiment option for feeding table lengths suitable for large laminar substrates, so that each suction area can be activated or deactivated according to the lengths of the substrates being fed at any given time.

According to a feature of the invention, the laminar substrate feeder comprises a separator that can be fixed on the feeding table for separation and alignment of laminar substrates when they are fed in parallel. Since the suction table is stationary, there is no need for a movable separator design as in the state of the art, thus reducing manufacturing difficulty and costs, and being a more reliable embodiment with no mechanical elements susceptible to failure. This feature in combination with the aforementioned means for laterally moving the laminar substrate makes it possible to bring the substrate against the separator to act as a reference, which was not possible in the state of the art because of the space between the separator and the feeding table for lifting the table itself.

According to another feature of the invention, the laminar substrate feeder comprises means for moving the same to another location, preferably wheels that allow its movement in the direction of movement of the substrate during its feed, in order to connect same to the corresponding processing machine, or to carry out maintenance work.

According to another aspect, the invention also relates to a laminar substrate processing machine, preferably an application machine for applying preparation products, with moving means in the direction of movement of the laminar substrate, and connectable to the feeding inlet of the processing machine, in this case to the preparation product application rollers, the substrate feeder comprising a secondary suction table at the gauge outlet providing the necessary traction for feeding the substrate to the processing machine. It should be mentioned that conventionally such processing machines comprise a feeding table with suction and with wheels at the inlet for feeding and acceleration of the laminar substrate coming from the laminar substrate feeder, however, with this configuration it is possible to dispense with the feeding table in the application machine for applying preparation products, being able to couple the same to the laminar substrate feeder. This configuration facilitates maintenance work, especially for cleaning, by providing better access to the dosing rollers and the rollers for applying preparation products of the processing machine. In addition, a continuity is provided for the transport of laminar substrates.

### DESCRIPTION OF THE FIGURES

FIG. 1 shows a schematic elevation view of a laminar substrate feeder according to the state of the art before the laminar substrate starts to move.

FIG. 2 shows a schematic elevation view of a laminar substrate feeder according to the state of the art with the black arrow indicating the elevation of the suction table.

FIG. 3 shows a schematic elevation view of a laminar substrate feeder according to the state of the art with the black arrow indicating the lowering of the suction table.

FIG. 4 shows a schematic elevation view of a preferred embodiment of a laminar substrate feeder according to the object of the invention before the laminar substrate starts to move.

FIG. 5 shows a schematic elevation view of a preferred embodiment of a laminar substrate feeder according to FIG. 4 at the moment when the rear flank of the laminar substrate has passed over the first wheel axle.

FIG. 6 shows a schematic elevation view of a preferred embodiment of a laminar substrate feeder according to FIG. 4 at the moment when the rear flank of the laminar substrate has passed over the second wheel axle.

FIG. 7 shows a schematic elevation view of a preferred embodiment of a laminar substrate feeder according to FIG. 4 at the moment when the rear flank of the laminar substrate has reached the last wheel axle.

FIG. 8 shows a schematic elevation view of a preferred embodiment of a laminar substrate feeder according to FIG. 4 at the moment the laminar substrate has exited the passage gauge.

FIG. 9 shows a schematic perspective/upper view of an alternative embodiment of the laminar substrate feeder with two feeding lines.

FIG. 10 shows a schematic elevation view of an alternative embodiment of the invention with a longer suction table.

FIG. 11 shows a schematic elevation view of a laminar substrate feeder coupled to an application machine for applying preparation products according to the state of the art.

FIG. 12 shows a schematic elevation view of a preferred embodiment of a laminar substrate feeder coupled to an application machine for applying preparation products according to the object of the invention.

### DETAILED DESCRIPTION OF THE INVENTION

In light of the aforementioned figures, and in accordance with the adopted numbering, one may observe therein a preferred exemplary embodiment of the invention, which comprises the parts and elements indicated and described in detail below.

According to FIGS. 1 to 3, an exemplary embodiment according to the state of the art can be seen. As can be seen in FIG. 1, the length L2 from the passage gauge (4′) to the point where the cardboard sheet (3.1′) is pressed by a press roller (10′) must be shorter than the length L1 from the rear flank or edge of the cardboard sheet (3.1′) to the vertical of the axle of the first wheels (6′) which said edge of the cardboard sheet (3.1′) would find during its path so as to ensure that no wheel (6′) is in moving contact with the following cardboard sheet to be fed. Since it is necessary to comply with said ratio between the lengths L1 and L2, for shorter substrates such as a cardboard sheet (3.1′) of about 600 mm in length, the feeding table (5′) would be limited in length resulting in a feeding table (5′) which would not be valid for long cardboard sheets (3.1′).

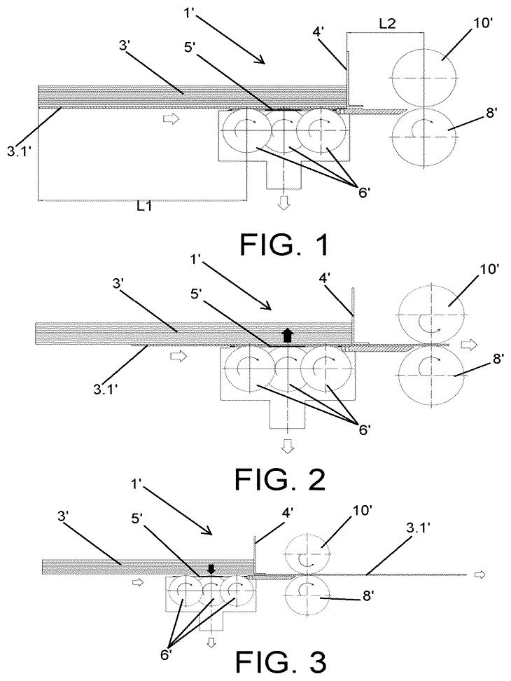

Furthermore, in order to prevent the following cardboard sheet from coming into contact with the wheels (6′) when the outgoing cardboard sheet (3.1′) is being fed, as can be seen in FIG. 2, a feeding table (5′) is raised, so that when said feeding table (5′) is raised, as the wheels (6′) are stationary, they do not come into contact with the following cardboard sheet (3′).

Once the rear edge of the cardboard sheet (3.1′) has passed through the gauge (4′) and is pulled by the press roller (10′) and the feeding roller (8′), as shown in FIG. 3, the suction table (5′) is lowered to its initial position allowing the following cardboard sheet to be lowered and make contact with the wheels (6′) for its movement.

As indicated above, this movement of the suction table (5′) generates friction on the cardboard sheets (3.1′), and when the suction table (5′) is in the raised position, the cardboard sheet (3.1′) is slowed down by the friction with the suction table (5′), so that more traction is needed with the feed roller (8′) which requires the pressure exerted by the press roller (10′) to be greater, and as a result marks and defects are produced on the cardboard sheets (3.1′) which make it necessary to discard the same.

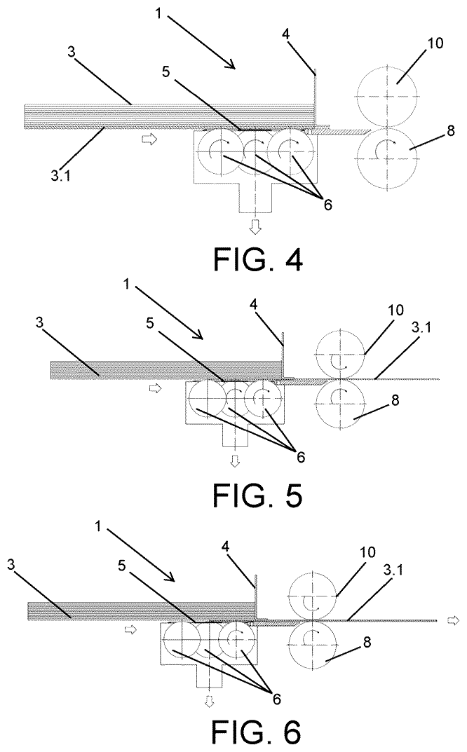

In order to solve these problems arising in the state of the art, a cycle of the feeding process of an exemplary practical embodiment of a laminar substrate feeder (1) according to the invention can be visualised with reference to FIGS. 4 to 8, the laminar substrate preferably being a cardboard sheet (3.1).

FIG. 4 shows how the cardboard sheet (3.1) of the cardboard (3) stack, due to the weight on top of the stack of cardboard (3), makes contact with the feeding table (5) with suction and the corresponding wheels (6) that rotate to apply the necessary acceleration for the feeding of the cardboard sheet (3.1) to a processing machine.

The novelty of the invention is in the instant of the cycle represented in FIG. 5, in this case the suction table (5) is stationary, and to avoid that the following cardboard sheet can be pulled before due time, once the rear edge of the cardboard sheet (3.1) has reached the vertical of the axle of the first wheels (6), so that said axle stops when passing the vertical and before the following cardboard sheet makes contacts with the wheels (6). The remaining wheel axles (6) shall remain in motion providing traction to the board (3.1).

In order to perform said axle stop, the invention preferably comprises an independent drive for each wheel axle (6), said drive preferably being a servomotor, so that the cardboard feeder (1) comprises control means which send the stop signal to the servomotor driving the first wheel axle (6).

The time at which the rear flank of the cardboard sheet (3.1) has reached the first wheel axle (6) shall be calculated by the control means, for example by reading times at the outlet of the rollers (8, 10) where the front and rear flanks of the cardboard sheets (3.1) are read to check that the feeding is being carried out correctly.

Thus, the control means, depending on said readings and the dimensions of the cardboard sheet (3.1) and the feed speeds etc., calculates when the rear flank of the cardboard sheet (3.1) will reach the wheel axle (6), and with this information it will send the stop signal to the servomotor.

As can be seen in FIG. 6, when the rear flank of the cardboard sheet (3.1) reaches the second wheel axle (6), the second servomotor will stop in the same manner as the first one, leaving the third wheel axle (6) in motion. In this configuration, the following cardboard sheet will rest on the stationary feeding table (5) with suction, but will not be dragged as it has no traction, and the outgoing cardboard sheet (3.1) will have sufficient traction to not need a press roller (10) or so that the pressure exerted by the press roller (10) is minimal and does not cause defects in the cardboard sheets (3.1).

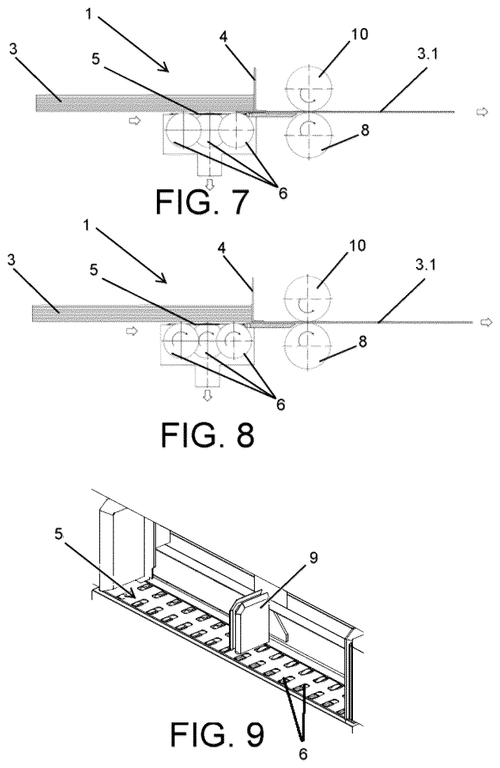

Referring to FIG. 7, once the rear flank of the cardboard sheet (3.1) has passed the last wheel axle (6), the last axle and its corresponding wheels (6) shall stop and the cardboard sheet (3.1) shall be fed into the processing machine with sufficient traction provided by the roller (8) and/or its press roller (10).

At the end of the cycle, once the stack of cardboard sheets has released the rear edge of the substrate in its path, all the wheel axles (6) will be driven by the servomotors to provide traction to the following cardboard sheet and start a new cycle.

According to an alternative embodiment, FIG. 9 shows a cardboard feeder arrangement (1) with two feeding lines, comprising a separator (9) fixed to the feeding table (5) that separates and guides both cardboard sheets (3.1). In this case, the adjustment to the different dimensions of the cardboard sheets is carried out by means of holding and guiding means of the storage area of the stack of cardboard sheets (3), said separator (9) remaining stationary at all times on the feeding table (5). This arrangement facilitates manufacturing and avoids the errors and faults that can occur in solutions known in the state of the art that comprise a hollow between the feeding table and the separator to allow the feeding table to be raised.

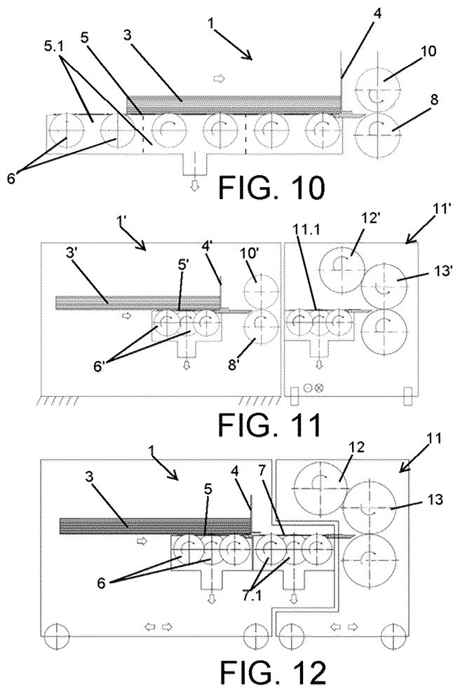

FIG. 10 shows an exemplary embodiment in which, thanks to the advantages provided by the invention, in particular the increased traction provided by the wheels (6) that maintain the movement of the cardboard sheet (3.1) until same comes out through the gauge (4), it is possible to use cardboard sheets (3.1) of greater length, even up to 5000 mm, for example. This will require a longer suction table (5) to have more wheels (6) to provide more traction.

In this case, the suction table (5) is segmented so that there are several suction areas (5.1) in order to adapt to the different lengths. Depending on the length of the stack of cardboard sheets (3), the control means shall close the suction of the suction areas (5.1) which lie outside the length of the stack of cartons (3) and the corresponding wheel axles (6) shall be prevented from moving. This results in a versatile cardboard feeder (1) suitable for different cardboard lengths (3.1).

According to another aspect of the invention there is also a cardboard processing machine couplable to the carton feeder (1), and the assembly formed by both machines. The processing machine preferably being, for the practical embodiment shown in the figures, an application machine for applying preparation products (11).

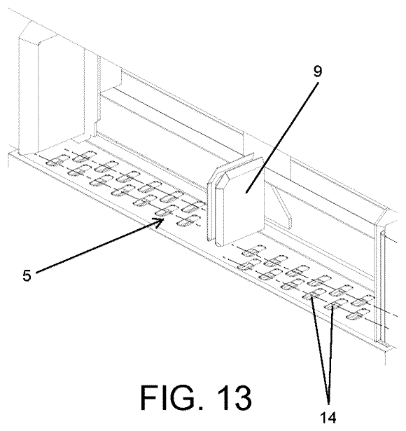

From the state of the art shown in FIG. 11, it can be seen that conventionally the cardboard feeder (1′) is arranged stationary in a production line, while the application machine for applying preparation products (11′) is movable in the direction perpendicular to the sheet.

For this embodiment of the state of the art, the application machine for applying preparation products (11′) comprises a feeding table (11.1) with suction for feeding the cardboard sheet (3.1) to provide the necessary speed to said cardboard sheet (3.1) at the inlet of the application rollers (13′). With this solution, for maintenance work, the machine (11′) is detached from the cardboard feeder (1′), however, for cleaning the dosing roller (12′) and the application rollers (13′), access is difficult due to the presence of the feeding table (11.1) with suction which prevents easy access to said rollers for cleaning, resulting in long maintenance stoppages which considerably reduce production.

This problem is solved in the invention, for an embodiment in which the cardboard feeder (1) comprises a secondary suction table (7) with its corresponding wheels (7.1) at the gauge (4) outlet. With this configuration, the appropriate speed is provided to the cardboard sheet (3.1) in accordance with the requirements of the application rollers (13) of the application machine for applying preparation products (11), and as it is not necessary to include the feed roller (8) and its corresponding press roller (10) due to the traction provided by the secondary suction table (7), in this case the cardboard feeder (1) can be directly coupled to an application machine for applying preparation products (11) without a feed suction table (11.1).

As can be seen in FIG. 12, both the cardboard feeder (1) and the application machine for applying preparation products (11) have moving means in the direction of movement of the cardboard sheet (3.1), so that they can be directly coupled, providing continuity in the movement of the cardboard sheet (3.1) from the stack of cardboard sheets (3) to the application roller (13) of the application machine for applying preparation products (11).

In an alternative embodiment, as shown in FIG. 13, the feeding table (5) comprises means for laterally moving the cardboard sheet (3.1), in this case, rotation axles with wheels (6) inclined with respect to the perpendicular to the direction of movement of the cardboard sheet (3.1), so that the cardboard sheet (3.1) moves towards the lateral guide of the supplying and guiding area (2) or towards the separator (5), to be used as a reference for feeding the cardboard sheet (3.1) to the processing machine.

All the above-mentioned distinctive features of the invention provide higher productivity by achieving higher cardboard sheet feed speeds, no defects due to friction, no treading of the press roller, and no jamming. It also provides a smoother movement to avoid misalignment, etc.

1. A laminar substrate feeder for processing machines comprising:
elements for supplying and guiding at least one stack of laminar substrates with an adjustable height gauge for the passage of a single laminar substrate at a time,
a feeding table with suction with a plurality of wheels integral with at least one rotation axle for feeding by means of the movement of the laminar substrate, and
traction means located after the gauge in the direction of movement of the laminar substrate to direct the laminar substrate to the processing machine,
wherein the feeding table is stationary, and it comprises control means configured to selectively stop the rotation of the corresponding rotation axle.

2. The laminar substrate feeder according to claim 1, wherein the control means are configured to stop the corresponding rotation axle prior to the laminar substrate following the laminar substrate being fed making contact with the wheels on said axle.

3. The laminar substrate feeder according to claim 1, comprising a plurality of rotation axles with their corresponding wheels comprising drive means for each rotation axle and/or group of axles, the control means being configured to stop the drive means corresponding to the axle or group of axles to be stopped prior to the laminar substrate following the laminar substrate being fed making contact with the wheels of the corresponding rotation axle.

4. The laminar substrate feeder according to claim 1, wherein the wheels are configured to have free movement in the event that their rotation axle is stopped.

5. The laminar substrate feeder according to claim 1, wherein at least one rotation axle can rotate in the reverse direction to the direction of travel of the cardboard sheet.

6. The laminar substrate feeder according to claim 1, wherein the feeding table comprises means for laterally moving the laminar substrate.

7. The laminar substrate feeder according to claim 6, wherein the means for laterally moving the laminar substrate are at least one wheel configured to laterally move the laminar substrate towards the lateral guide of the supplying and guiding elements.

8. The laminar substrate feeder according to claim 1, wherein the traction means is at least one feed roller.

9. The laminar substrate feeder according to claim 1, wherein the traction means are a secondary feeding table with suction and with moving wheels with independently driven axles and/or axles driven together by a single drive.

10. The laminar substrate feeder according to claim 3, wherein the drive means are servomotors.

11. The laminar substrate feeder according to claim 1, wherein the feeding table comprises at least two suction areas the control means being configured to selectively activate/deactivate said suction areas.

12. The laminar substrate feeder according to claim 1, comprising a separator attachable to the feeding table for separating laminar substrates when they are fed in parallel.

13. The laminar substrate feeder according to claim 1, comprising moving means for moving the same to another location.

14. A processing machine with moving means for moving the machine, and connected at a its feeding inlet to a cardboard feeder.

15. A processing machine with moving means for moving the machine, and connected at a feeding inlet to the laminar substrate feeder according to claim 7.
